(19) United States
(12) Patent Application Publication
(10) Pub. No.: US 2015/0024314 A1
(43) Pub. Date: Jan. 22, 2015

(54) TONER ADDITIVES TO PREVENT BIAS ROLLER CONTAMINATION

(71) Applicant: XEROX CORPORATION, NORWALK, CT (US)

(72) Inventors: Richard Philip Nelson Veregin, Mississauga (CA); Thomas Edward Enright, Tottenham (CA); Thomas R. Pickering, Webster, NY (US); Richard A. Klenkler, Oakville (CA); Cuong Vong, Hamilton (CA)

(73) Assignee: XEROX CORPORATION, NORWALK, CT (US)

(21) Appl. No.: 13/946,944

(22) Filed: Jul. 19, 2013

(51) Int. Cl. G03G 9/097

(52) U.S. Cl. CPC G03G 9/09716
USPC 430/108.3

(57) ABSTRACT

A toner composition includes toner particles and additives disposed on an exterior surface of the toner particles, the additives include uncoated particles satisfying the equation:

14.428−1.793×density(g/cm³)−1,363,353×conductivity(ohm·cm⁻¹)≦6;

surface-treated silica, surface-treated titania, and spacer particles, the toner composition is substantially free of a rare earth compound and the uncoated particles are present in a sufficient amount to reduce bias charge roller contamination.

### CROSS-REFERENCE TO RELATED APPLICATIONS

Reference is made to commonly owned and co-pending, U.S. patent application Ser. No. ______ (not yet assigned) entitled “BARIUM TITANATE TONER ADDITIVE” to Enright et al., electronically filed on the same day herewith (Attorney Docket No. 20121204-420030), U.S. patent application Ser. No. ______ (not yet assigned) entitled “ZIRCONIUM OXIDE TONER ADDITIVE” to Enright et al., electronically filed on the same day herewith (Attorney Docket No. 20121205-420029), U.S. patent application Ser. No. ______ (not yet assigned) entitled “SILICON CARBIDE TONER ADDITIVE” to Enright et al., electronically filed on the same day herewith (Attorney Docket No. 20121204-420033), the disclosures of which are hereby incorporated by reference in its entirety.

### FIELD

Embodiments disclosed herein relate to toner compositions. In particular, embodiments disclosed herein relate to toner compositions comprising non-rare earth particle additives that mitigate bias charge roller (BCR) contamination.

### BACKGROUND

Image forming devices including copiers, printers, facsimile machines, scanners and the like, include a photoreceptor or photoconductor component, the surface of which is typically charged to a uniform electrical potential and then selectively exposed to light in a pattern corresponding to an original image. Those areas of the photoconductive surface exposed to light are discharged, thus forming a latent electrostatic image on the photoconductive surface.

A developer material, such as toner, having an electrical charge such that the toner is attracted to the photoconductive surface, is brought into contact with the photoreceptor's photoconductive surface. A recording sheet, such as a blank sheet of paper or a transfer belt, is then brought into contact with the photoconductive surface and the toner thereon is transferred to the recording sheet in the form of the latent electrostatic image. The recording sheet may then be heated thereby permanently fusing the toner.

A photoconductive drum, for example, is typically charged to a substantial voltage, such as a voltage greater than 1,000 V DC. This voltage could be either positive or negative with respect to ground, depending upon the charging system and the chemicals used in the photoconductive drum material. Additionally, an AC voltage superimposed on the DC voltage may be employed.

For a photoconductive drum to achieve this substantially large voltage, it is typical for a bias charge roller (BCR) to be placed into contact with the surface of the photoconductive drum. The bias charge roller typically comprises a moderately electrically conductive component, or a semiconductive component, which has an electrically conductive center that receives a high voltage from a high voltage power supply. As voltage is received at the electrically conductive center, this voltage charges the entire bias charge roller, including its outer cylindrical surface. This high voltage at the cylindrical surface of the BCR is then passed onto the outer surface of the photoconductive drum as the drum rotates.

The ability of the bias charge roller to charge the photoconductive drum decreases over its life due to roller characteristics and contamination of the surface of the roller. This decrease in ability to charge may, over time, impact the ability of the photoconductive drum to produce accurate prints. Consequently, it is desirable to reduce buildup of contamination that occurs on the surface of the bias charge roller which may subsequently decrease bias charge roller life or reduce print quality.

### SUMMARY

According to embodiments illustrated herein, there are provided toner compositions comprising uncoated particles that mitigate bias charge roller contamination.

In some aspects, embodiments disclosed herein relate to a toner composition comprising toner particles and a plurality of additives disposed on an exterior surface of the toner particles, the additives comprising uncoated particles satisfying the equation:

14.428−1.793×density(g/cm³)−1,363,353×conductivity(ohm·cm⁻¹)≦6;

surface-treated silica, surface-treated titania, and spacer particles, wherein the toner composition is substantially free of a rare earth compound and wherein the uncoated particles are present in a sufficient amount to reduce bias charge roller contamination.

In some aspects, embodiments disclosed herein relate to a toner composition comprising toner particles and a toner additive disposed on an exterior surface of the toner particles, the toner additive comprising uncoated particles having a density greater than or equal to about 4.7 g/cm³ and a conductivity greater than or equal to about 2×10⁻¹¹ ohm·cm⁻¹, wherein the toner composition is substantially free of one or more rare earth compounds and wherein the uncoated particles are present in a sufficient amount to reduce bias charge roller contamination.

In some aspects, embodiments disclosed herein relate to a toner composition comprising toner particles and a plurality of additives disposed on an exterior surface of the toner particles, the additives comprising about 0.20 weight percent to about 0.50 weight percent of uncoated particles having a density greater than or equal to about 4.7 g/cm³ and a conductivity greater than or equal to about 2×10⁻¹¹ ohm·cm⁻¹, surface-treated silica, surface-treated titania, and spacer particles, wherein the toner composition is substantially free of one or more rare earth compounds.

### BRIEF DESCRIPTION OF THE DRAWINGS

For a better understanding of the present embodiments, reference may be made to the accompanying figures.

FIG. 1 shows a print pattern for a machine test (50% AC Process Black; actual density per color about 93% fill) used in generating the data of FIG. 2.

FIG. 2 shows a series of photographs comparing various additives indicating their ability to prevent or reduce bias charge roller contamination.

FIG. 3 shows a plot of visual ranking of bias charge roller contamination as a function of density.

FIG. 4 shows a plot of visual ranking of bias charge roller contamination as a function of conductivity.

FIG. 5 shows a plot of predicted of bias charge roller contamination as a function of density and inverse resistivity versus measured visual ranking of bias charge roller contamination.

### DETAILED DESCRIPTION

In the following description, it is understood that other embodiments may be utilized and structural and operational changes may be made without departure from the scope of the present embodiments disclosed herein.

Cerium dioxide (Mirek E10 brand CeO₂, available from Mitsui Mining and Smelting Co., Ltd., Tokyo, JP) is a rare earth material that can be employed as a toner additive, including toner compositions comprising toner particles produced via emulsion aggregation. It has been postulated that cerium dioxide may serve as a photoreceptor cleaning agent, specifically for machines that have a photoreceptor cleaning blades as part of their architecture. Recent increases in the cost of cerium and other rare earth elements have prompted a search for replacement additives that address filming on the photoreceptor surface while reducing costs.

As disclosed herein, a number of alternative additives were selected based on their polishing capabilities along with similar physical properties to CeO₂, including inter alia, similar particle size. It was discovered that all of these alternative additives had generally good photoreceptor filming prevention capabilities. However, it was surprisingly discovered that CeO₂ serves a secondary function previously unrecognized in the art. As indicated in the Examples below, only certain candidates also prevented contamination of the bias charge roller (BCR) in the imaging system. Thus, while all of the candidates prevented photoreceptor filming, results varied in their ability to control BCR contamination. As BCR contamination is one of the main failures of machines in the field and it causes non-uniform photoreceptor charging that results in print defects, embodiments disclosed herein advantageously provide toner compositions which prevent both photoreceptor filming and reduce or prevent BCR contamination.

In accordance with embodiments disclosed herein, non-rare element particles having a select combination of density and conductivity may be used to replace cerium dioxide as a toner additive as a photoreceptor cleaning agent while also providing protection against BCR contamination. Toner additives that have both high density and high conductivity have been found to be particularly effective in preventing bias charging roller contamination, resulting in significant cost savings and improvement in supply assurance.

In accordance with some embodiments, a non-rare earth oxide particle employed as a toner additive (external to the toner particles) may reduce BCR contamination when the particle has a density of greater than or equal to about 4.7 g/cm³ while also having a conductivity greater than or equal to about 2×10⁻¹¹ (ohm·cm)⁻¹. In particular embodiments, selection of an appropriate non-rare earth oxide particle competent to reduce BCR contamination may be governed by Equation (1) below:

14.428−1.793×Density−13633563×conductivity≦6 Eqn. (1)

where density is measured in g/cm³ and conductivity is in (ohm·cm)⁻¹.

Preventing bias charging roll contamination results in significant cost savings, while the substitution of appropriate non-rare earth particle additives in lieu of cerium dioxide appears to have no negative impacts on other toner properties.

In some embodiments, there are provided toner compositions comprising toner particles and a toner additive disposed on an exterior surface of the toner particles, the toner additive comprising uncoated particles having a density greater than or equal to about 4.7 g/cm³ and a conductivity greater than or equal to about 2×10⁻¹¹ ohm·cm⁻¹, wherein the toner composition is substantially free of one or more rare earth compounds and wherein the uncoated particles are present in a sufficient amount to reduce bias charge roller contamination.

### Exemplary Toner Additives for Reducing BCR Contamination

Without being bound by theory, it has been postulated that toner additives disclosed herein function by dissociating from the toner particles allowing them to freely move to the photoreceptor where they may limit various toner components from moving to the BCR. Because the toner additives do not remain on the toner particles, toner charging, flow or other development properties are unaffected. Thus, the treatment and/or coating of the toner additive to control charge, adhesion or water adsorption is unnecessary. Such unprocessed toner additives can provide beneficial cost savings. Moreover, treatments and/or coatings, if they were employed on the toner additives disclosed herein, could reduce the density of the particles and result in a softer toner additive, which could interfere with its ability to function on the photoreceptor to improve BCR cleaning. Thus, in particular embodiments, the toner additives are neither treated nor coated in any manner.

I. Zirconium Oxide

In some embodiments, toner compositions disclosed herein comprise toner additives comprising uncoated zirconium oxide. As used in conjunction with zirconium oxide particles, “uncoated” refers to zirconium oxide particles specifically lacking hydrophobic modification, polymer encapsulation, surfactant modification, and the like. As an additive exterior to the surface of the toner particles the uncoated zirconium oxide particles are also not embedded in the toner particles and the uncoated zirconium oxide particles are configured to freely dissociate from the toner particles.

In embodiments, the uncoated zirconium oxide may contain other oxides in the structure, including silicon dioxide, titanium dioxide, strontium oxide, aluminum oxide, and the like. By way of example only, Zirox K, a commercially available source of zirconium oxide, includes about 85% zirconium dioxide and about 15% silicon dioxide.

In some embodiments, the uncoated zirconium oxide particles are present in a range of from about 0.25 to about 1.0, from about 0.30 to about 0.50, or from about 0.35 to about 0.45 weight percent, or about 0.41 weight percent of the total weight of the blended toner particles.

II. Barium Titanate

In some embodiments, toner compositions disclosed herein comprise additives comprising uncoated barium titanate. As used in conjunction with barium titanate particles, “uncoated” refers to barium titanate particles specifically lacking hydrophobic modification, polymer encapsulation, surfactant modification, and the like. As an additive exterior to the surface of the toner particles the uncoated barium titanate particles are also not embedded in the toner particles. In practice, the uncoated barium titanate particles are configured to freely dissociate from the toner particles.

In some embodiments, the uncoated barium titanate particles are present in a range of from about 0.25 to about 0.75, from about 0.40 to about 0.60, or from about 0.45 to about 0.55 weight percent, or about 0.50 weight percent of the total weight of the blended toner particles.

III. Silicon Carbide

In some embodiments, toner compositions disclosed herein comprise additives comprising uncoated silicon carbide. As used in conjunction with silicon carbide particles, “uncoated” refers to silicon carbide particles specifically lacking hydrophobic modification, polymer encapsulation, surfactant modification, and the like. As an additive exterior to the surface of the toner particles the uncoated silicon carbide particles are also not embedded in the toner particles. In practice, the uncoated silicon carbide particles are configured to freely dissociate from the toner particles.

In some embodiments, the uncoated silicon carbide particles are present in a range of from about 0.10 to about 0.40, from about 0.15 to about 0.35, or from about 0.20 to about 0.30 weight percent, or about 0.27 weight percent of the total weight of the blended toner particles.

In some embodiments, the uncoated toner additive particles have an average particle size in a range of from about 0.2 microns to about 1.5 microns. In other embodiments, the average particle size may be in a range of from about 0.4 to about 0.8 microns, or from about 0.5 to about 0.7 microns, including any values between the recited ranges. In some embodiments, the uncoated silicon carbide particles may be irregular in shape or substantially spherical.

The toner compositions disclosed herein include externally applied additives which include the uncoated toner additive particles described herein above that satisfy characteristic density and conductivity properties. In some embodiments, the toner additives may further comprise at least one of surface-treated silica, surface-treated titania, spacer particles, and combinations thereof. The toner additives may be packaged together as an additives package to add to the toner composition. That is, the toner particles are first formed, followed by mixing of the toner particles with the materials of the toner additives package. The result is that some components of the additive package may coat or adhere to external surfaces of the toner particles, rather than being incorporated into the bulk of the toner particles. The uncoated toner additives, however, are not specifically designed to adhere to the toner particles per se as they ideally are sufficiently free flowing to provide the requisite BCR contamination prevention, in accordance with embodiments disclosed herein.

### Silica

Any suitable untreated silica or surface treated silica can be used. Such silicas can be used alone, as only one silica, or can be used in combination, such as two or more silicas. Where two or more silicas are used in combination, it is may be beneficial, although not required, that one of the surface treated silicas be a decyl trimethoxysilane (DTMS) surface treated silica. In particular embodiments, the silica of the decyl trimethoxysilane (DTMS) surface treated silica may be a fumed silica.

Conventional surface treated silica materials are known and include, for example, TS-530 from Cabosil Corporation, with an 8 nanometer particle size and a surface treatment of hexamethyldisilazane; NAX50, obtained from Evonik Industries/Nippon Aerosil Corporation, coated with HMDS; H2050EP, obtained from Wacker Chemie, coated with an amino functionalized organopolysiloxane; CAB-O-SIL® fumed silicas such as for example TG-709F, TG-308F, TG-810G, TG-811F, TG-822F, TG-824F, TG-826F, TG-828F or TG-829F with a surface area from 105 to 280 m²/g obtained from Cabot Corporation; and the like. Such conventional surface treated silicas are applied to the toner surface for toner flow, triboelectric charge enhancement, admix control, improved development and transfer stability, and higher toner blocking temperature.

In other embodiments, other surface treated silicas can also be used. For example, a silica surface treated with polydimethylsiloxane (PDMS), can also be used. Specific examples of suitable PDMS-surface treated silicas include, for example, but are not limited to, RY50, NY50, RY200, RY200S and R202, all available from Nippon Aerosil, and the like.

In some embodiments, the silica additive is a surface-treated silica. When so provided, the surface treated silica may be the only surface treated silica present in the toner composition. As described below, the additive package may also beneficially include large-sized sol-gel silica particles as spacer particles, which is distinguished from the surface treated silica described herein. Alternatively, for example where small amounts of other surface treated silicas are introduced into the toner composition for other purposes, such as to assist toner particle classification and separation, the surface treated silica is the only xerographically active surface treated silica present in the toner composition. Any other incidentally present silica thus does not significantly affect any of the xerographic printing properties. In some embodiments, the surface treated silica is the only surface treated silica present in the additive package applied to the toner composition. Other suitable silica materials are described in, for example, U.S. Pat. No. 6,004,714, the entire disclosure of which is incorporated herein by reference.

In some embodiments, the silica additive may be present in an amount of from about 1 to about 4 percent by weight, based on a weight of the toner particles without the additive or, in an amount of from about 0.5 to about 5 parts by weight additive per 100 parts by weight toner particle or from about 1.6 weight percent to about 2.8 weight percent or from about 1.5 or from about 1.8 to about 2.8 or to about 3 percent by weight.

In some embodiments, the silica has an average particle size of from about 10 to about 60 nm, or from about 15 to about 55 nm, or from about 20 to about 50 nm.

### Titania

Another component of the additive package is a titania, and in embodiments a surface treated titania. In some embodiments, the surface treated titania used in embodiments is a hydrophobic surface treated titania.

Conventional surface treated titania materials are known and include, for example, metal oxides such as TiO₂, for example MT-3103 from Tayca Corp. with a 16 nanometer particle size and a surface treatment of decylsilane; SMT5103, obtained from Tayca Corporation, comprised of a crystalline titanium dioxide core MT500B coated with DTMS; P-25 from Degussa Chemicals with no surface treatment; an isobutyltrimethoxysilane (i-BTMS) treated hydrophobic titania obtained from Titan Kogyo Kabushiki Kaisha (IK Inabata America Corporation, New York); and the like. Such surface treated titania are applied to the toner surface for improved relative humidity (RH) stability, triboelectric charge control and improved development and transfer stability.

While any of the conventional and available titania materials can be used, it may be beneficial that specific surface treated titania materials be used, which have been found to unexpectedly provide superior performance results in toner compositions. Thus, while any of the surface treated titania may be used in the additive package, in some embodiments the material may be a “large” surface treated titania (i.e., one having an average particle size of from about 30 to about 50 nm, or from about 35 to about 45 nm, particularly about 40 nm). In particular, it has been found that the surface treated titania provides one or more of better cohesion stability of the toners after aging in the toner housing, and higher toner conductivity, which increases the ability of the system to dissipate charge patches on the toner surface.

Specific examples of suitable surface treated titanias include, for example, but are not limited to, an isobutyltrimethoxysilane (i-BTMS) treated hydrophobic titania obtained from Titan Kogyo Kabushiki Kaisha (IK Inabata America Corporation, New York); SMT5103, obtained from Tayca Corporation or Evonik Industries, comprised of a crystalline titanium dioxide core MT500B coated with DTMS (decyltrimethoxysilane); and the like. The decyltrimethoxysilane (DTMS) treated titania is particularly beneficial, in some embodiments.

In some embodiments, only one titania, such as surface treated titania, is present in the toner composition. That is, in some embodiments, only one kind of surface treated titania is present, rather than a mixture of two or more different surface treated titanias.

The titania additive may be present in an amount of from about 0.5 to about 4 percent by weight, based on a weight of the toner particles without the additive, or about 0.5 to about 2.5, or about 0.5 to about 1.5, or about 2.5 or to about 3 percent by weight. In some embodiments, the surface-treated titania has an average particle size of from about 10 to about 60 nm, or from about 20 to about 50 nm, such as about 40 nm.

### Spacer Particles

Another component of the additive package is a spacer particle. In some embodiments, the spacer particles have an average particle size of from about 100 to about 150 nm. In some embodiments, the spacer particles are selected from the group consisting of latex particles, polymer particles, and sol-gel silica particles. In some embodiments, the spacer particle used in embodiments is a sol-gel silica.

Spacer particles, particularly latex or polymer spacer particles, are described in, for example, U.S. Patent Application Publication No. 2004/0137352, the entire disclosure of which is incorporated herein by reference.

In some embodiments, the spacer particles are comprised of latex particles. Any suitable latex particles may be used without limitation. As examples, the latex particles may include rubber, acrylic, styrene acrylic, polyacrylic, fluoride, or polyester latexes. These latexes may be copolymers or crosslinked polymers. Specific examples include acrylic, styrene acrylic and fluoride latexes from Nippon Paint (e.g. FS-101, FS-102, FS-104, FS-201, FS-401, FS-451, FS-501, FS-701, MG-151 and MG-152) with particle diameters in the range from 45 to 550 nm, and glass transition temperatures in the range from 65° C. to 102° C.

These latex particles may be derived by any conventional method in the art. Suitable polymerization methods may include, for example, emulsion polymerization, suspension polymerization and dispersion polymerization, each of which is well known to those versed in the art. Depending on the preparation method, the latex particles may have a very narrow size distribution or a broad size distribution. In the latter case, the latex particles prepared may be classified so that the latex particles obtained have the appropriate size to act as spacers as discussed above. Commercially available latex particles from Nippon Paint have very narrow size distributions and do not require post-processing classification (although such is not prohibited if desired).

In a further embodiment, the spacer particles may also comprise polymer particles. Any type of polymer may be used to form the spacer particles of this embodiment. For example, the polymer may be polymethyl methacrylate (PMMA), e.g., 150 nm MP1451 or 300 nm MP116 from Soken Chemical Engineering Co., Ltd. with molecular weights between 500 and 1500K and a glass transition temperature onset at 120° C., fluorinated PMMA, KYNAR® (polyvinylidene fluoride), e.g., 300 nm from Pennwalt, polytetrafluoroethylene (PTFE), e.g., 300 nm L2 from Daikin, or melamine, e.g., 300 nm EPOSTAR-S® from Nippon Shokubai.

In some embodiments, the spacer particles on the surfaces of the toner particles are believed to function to reduce toner cohesion, stabilize the toner transfer efficiency and reduce/minimize development falloff characteristics associated with toner aging such as, for example, triboelectric charging characteristics and charge through. These additive particles function as spacers between the toner particles and carrier particles and hence reduce the impaction of smaller conventional toner external surface additives, such as the above-described silica and titania, during aging in the development housing. The spacers thus stabilize developers against disadvantageous burial of conventional smaller sized toner additives by the development housing during the imaging process in the development system. The spacer particles function as a spacer-type barrier, and therefore the smaller toner additives are shielded from contact forces that have a tendency to embed them in the surface of the toner particles. The spacer particles thus provide a barrier and reduce the burial of smaller sized toner external surface additives, thereby rendering a developer with improved flow stability and hence excellent development and transfer stability during copying/printing in xerographic imaging processes. The toner compositions of the present disclosure thereby exhibit an improved ability to maintain their DMA (developed mass per area on a photoreceptor), their TMA (transferred mass per area from a photoreceptor) and acceptable triboelectric charging characteristics and admix performance for an extended number of imaging cycles.

The spacer particles may be present in an amount of from about 0.3 to about 2.5 percent by weight, based on a weight of the toner particles without the additive, or from about 0.6 to about 1.8, or from about 0.5 to about 1.8 percent by weight.

In some embodiments, the spacer particles are large sized silica particles. Thus, in some embodiments, the spacer particles have an average particle size greater than an average particles size of the silica and titania materials, discussed above. For example, the spacer particles in this embodiment are sol-gel silicas. Examples of such sol-gel silicas include, for example, X24, a 120 nm sol-gel silica surface treated with hexamethyldisilazane, available from Shin-Etsu Chemical Co., Ltd. In some embodiments, the spacer particles may have an average particle size of from about 60 to about 300 nm, or from about 75 to about 205 nm, such as from about 100 nm to about 150 nm.

In some embodiments, there are provided toner compositions comprising toner particles and a plurality of additives disposed on an exterior surface of the toner particles, the additives comprising about 0.20 weight percent to about 0.50 weight percent of uncoated particles having a density greater than or equal to about 4.7 g/cm³ and a conductivity greater than or equal to about 2×10⁻¹¹ ohm·cm⁻¹, surface-treated silica, surface-treated titania, and spacer particles, wherein the toner composition is substantially free of one or more rare earth compounds. In some such embodiments, the uncoated particles have an average particle size in a range of from about 0.2 microns to about 1.0 microns. In some such embodiments, the toner particles are made by an emulsion/aggregation coalescence process.

In some embodiments, there are provided toner compositions comprising toner particles and a plurality of additives disposed on an exterior surface of the toner particles, the additives comprising uncoated particles satisfying the equation:

14.428−1.793×density(g/cm³)−1,363,353×conductivity(ohm·cm⁻¹)≦6

And surface-treated silica, surface-treated titania, and spacer particles, wherein the toner composition is substantially free of a rare earth compound and wherein the uncoated particles are present in a sufficient amount to reduce bias charge roller contamination. In some such embodiments, the uncoated non particles are present in a range of from about 0.20 weight percent to about 0.50 weight percent. In some such embodiments, the toner particles are made by an emulsion/aggregation coalescence process.

### Toner Particles

Suitable examples of toner latex resins or polymers may include non-crosslinked resin and crosslinked resin or gel combinations including, but not limited to, styrene acrylates, styrene methacrylates, butadienes, isoprene, acrylonitrile, acrylic acid, methacrylic acid, beta-carboxy ethyl acrylate, polyesters, polymers such as poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and the like. In some embodiments, the resin or polymer is a styrene/butyl acrylate/carboxylic acid terpolymer. In some embodiments, at least one of the resins is substantially free of crosslinking and the crosslinked resin comprises carboxylic acid in an amount of about 0.05 to about 10 weight percent based upon the total weight of the resin substantially free of crosslinking or crosslinked resin.

In some embodiments, the resin used in forming the toner particles can be one type of resin, or a mixture or combination of two or more types of resins. For example, a single resin (non-crosslinked or crosslinked) can be used to form the toner particles. Alternatively the toner particles can be formed by using a mixture of two or more resins, which are added together or separately, at the same time or not, during the toner particle formation process. In some embodiments, the resin used comprises two resins, one of which is non-crosslinked and the other of which is crosslinked.

In some embodiments, the resin that is substantially free of crosslinking (also referred to herein as a non-crosslinked resin) comprises a resin having less than about 0.1 percent crosslinking. For example, the non-crosslinked latex comprises in some embodiments styrene, butylacrylate, and beta-carboxyethylacrylate (beta-CEA) monomers, although not limited to these monomers. Resin particles may be formed de novo by emulsion polymerization in the presence of an initiator, a chain transfer agent (CTA), and surfactant.

In some embodiments, the resin substantially free of crosslinking comprises styrene:butylacrylate:beta-carboxy ethylacrylate wherein, for example, the non-crosslinked resin monomers are present in an amount from about 70% to about 90% styrene, about 10% to about 30% butylacrylate, and about 0.05 parts per hundred to about 10 parts per hundred beta-CEA, or about 3 parts per hundred beta-CEA, by weight based upon the total weight of the monomers, although not so limited. Other acrylate-based resins may comprise, without limitation, acrylic acid, methacrylic acid, itaconic acid, beta carboxyethyl acrylate (beta CEA), fumaric acid, maleic acid, and cinnamic acid.

In particular embodiments, the non-crosslinked resin may comprise about 73% to about 85% styrene, about 27% to about 15% butylacrylate, and about 1.0 part per hundred to about 5 parts per hundred beta-CEA, by weight based upon the total weight of the monomers although the compositions and processes are not limited to these particular types of monomers or ranges. In other embodiments, the non-crosslinked resin may comprise about 81.7% styrene, about 18.3% butylacrylate and about 3.0 parts per hundred beta-CEA by weight based upon the total weight of the monomers.

Emulsion polymerization initiators may include, without limitation, sodium, potassium or ammonium persulfate and may be present in the range of, for example, about 0.5 to about 3.0 percent based upon the weight of the monomers, although not limited. The CTA may be present in an amount of from about 0.5 to about 5.0 percent by weight based upon the combined weight of the monomers, although it is not so limited. In some embodiments, the surfactant may comprise an anionic surfactant present in the range of about 0.7 to about 5.0 percent by weight based upon the weight of the aqueous phase, although it is not limited to this type or range.

By way of example, the monomers may be polymerized under starve fed conditions as disclosed in U.S. Pat. Nos. 6,447,974, 6,576,389, 6,617,092, and 6,664,017, which are hereby incorporated by reference herein in their entireties, to provide latex resin particles having a diameter in a range from about 100 to about 300 nanometers. In some embodiments, the molecular weight of the non-crosslinked latex resin may be in a range from about 30,000 to about 37,000, or up to about 34,000, although it is not limited to this range.

In some embodiments, the onset glass transition temperature (T_{g}) of the non-crosslinked resin may be in the range from about 46° C. to about 62° C., or about 58° C., although it is not so limited. In some embodiments, the amount of acrylate-based monomers may be in a range of from about 0.04 to about 4.0 ppb of the resin monomers, although it is not so limited. In some embodiments, the number average molecular weight (Mn) may be in a range of from about 5000 to about 20,000, or about 11,000 daltons. In some embodiments, the prepared non-crosslinked latex resin has a pH of about 1.0 to about 4.0, or about 2.0.

In some embodiments, a crosslinked latex is prepared from a non-crosslinked latex comprising styrene, butylacrylate, beta-CEA, and divinyl benzene, by emulsion polymerization, in the presence of an initiator such as a persulfate, a CTA, and a surfactant. In some embodiments, the crosslinked resin monomers may be present in a ratio of about 60% to about 75% styrene, about 40% to about 25% butylacrylate, about 3 parts per hundred to about 5 parts per hundred beta-CEA, and about 3 parts per hundred to about 5 parts per hundred divinyl benzene, although not it is not so limited to these particular types of monomers or ranges. Any of the above-described monomers can also be used for forming the crosslinked latex or gel, as desired.

In some embodiments, the monomer composition may comprise, for example, about 65% styrene, 35% butylacrylate, 3 parts per hundred beta-CEA, and about 1 parts per hundred divinyl benzene, although the composition is not limited to these amounts. In some embodiments, the T_{g} (onset) of the crosslinked latex may be in a range of from about 40° C. to about 55° C., or about 42° C.

In some embodiments, the degree of crosslinking may be in a range of from about 0.3 percent to about 20 percent, although it is not so limited thereto, since an increase in the divinyl benzene concentration may increase the crosslinking.

In some embodiments, a soluble portion of the crosslinked latex may have a weight average molecular weight (Mw) of about 135,000 and a number average molecular weight (Mn) of about 27,000, but it is not so limited thereto.

In some embodiments, the particle diameter size of the crosslinked latex may be in a range of from about 20 to about 250 nanometers, or about 50 nanometers, although it is not so limited.

In some embodiments, the surfactant may be any surfactant, such as for example a nonionic surfactant or an anionic surfactant, such as, but not limited to, Neogen RK or Dowfax, both of which are commercially available. In some embodiments, the pH may be in a range of from about 1.5 to about 3.0, or about 1.8.

In some embodiments, the latex particle size can be, for example, from about 0.05 micron to about 1 micron in average volume diameter as measured by the Brookhaven nanosize particle analyzer. Other sizes and effective amounts of latex particles may be selected in some embodiments.

The latex resins selected for forming toner particles may be prepared, for example, by emulsion polymerization methods, and the monomers utilized in such processes may include the monomers listed above, such as, styrene, acrylates, methacrylates, butadiene, isoprene, acrylonitrile, acrylic acid, and methacrylic acid, and beta CEA. Known chain transfer agents, for example dodecanethiol, in effective amounts of, for example, from about 0.1 to about 10 percent, and/or carbon tetrabromide in effective amounts of from about 0.1 to about 10 percent, can also be employed to control the resin molecular weight during the polymerization.

Other processes for obtaining resin particles of from, for example, about 0.05 micron to about 1 micron can be selected from polymer microsuspension process, such as the processes disclosed in U.S. Pat. No. 3,674,736, the disclosure of which is incorporated herein by reference in its entirety, polymer solution microsuspension processes, such as disclosed in U.S. Pat. No. 5,290,654, the disclosure of which is incorporated herein by reference in its entirety, mechanical grinding or milling processes, or other known processes.

In some embodiments, toner particles may comprise a polyester resin such as an amorphous polyester resin, a crystalline polyester resin, and/or a combination thereof. The polymer used to form the resin can be a polyester resin described in U.S. Pat. Nos. 6,593,049 and 6,756,176, the disclosures of each of which are hereby incorporated by reference in their entirety. Suitable resins also include a mixture of an amorphous polyester resin and a crystalline polyester resin as described in U.S. Pat. No. 6,830,860, the disclosure of which is hereby incorporated by reference in its entirety.

The resin can be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 40 to about 60 mole percent, such as from about 42 to about 55 mole percent, or from about 45 to about 53 mole percent (although amounts outside of these ranges can be used), and the alkali sulfo-aliphatic diol can be selected in an amount of from about 0 to about 10 mole percent, such as from about 1 to about 4 mole percent of the resin (although amounts outside of these ranges can be used).

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, from about 40 to about 60 mole percent, in embodiments from about 42 to about 52 mole percent, such as from about 45 to about 50 mole percent (although amounts outside of these ranges can be used), and the alkali sulfo-aliphatic diacid can be selected in an amount of from about 1 to about 10 mole percent of the resin (although amounts outside of these ranges can be used).

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin can be present, for example, in an amount of from about 5 to about 50 percent by weight of the toner components, such as from about 10 to about 35 percent by weight of the toner components (although amounts outside of these ranges can be used). The crystalline resin can possess various melting points of, for example, from about 30° C. to about 120° C., in embodiments from about 50° C. to about 90° C. (although melting points outside of these ranges can be obtained). The crystalline resin can have a number average molecular weight (Mn), as measured by gel permeation chromatography (GPC) of, for example, from about 1,000 to about 50,000, such as from about 2,000 to about 25,000 (although number average molecular weights outside of these ranges can be obtained), and a weight average molecular weight (Mw) of, for example, from about 2,000 to about 100,000, such as from about 3,000 to about 80,000 (although weight average molecular weights outside of these ranges can be obtained), as determined by Gel Permeation Chromatography using polystyrene standards. The molecular weight distribution (Mw/Mn) of the crystalline resin can be, for example, from about 2 to about 6, in embodiments from about 3 to about 4 (although molecular weight distributions outside of these ranges can be obtained).

Examples of diacids or diesters including vinyl diacids or vinyl diesters used for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester can be present, for example, in an amount from about 40 to about 60 mole percent of the resin, such as from about 42 to about 52 mole percent of the resin, or from about 45 to about 50 mole percent of the resin (although amounts outside of these ranges can be used).

Examples of diols that can be used in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and combinations thereof. The amount of organic diol selected can vary, and can be present, for example, in an amount from about 40 to about 60 mole percent of the resin, such as from about 42 to about 55 mole percent of the resin, or from about 45 to about 53 mole percent of the resin (although amounts outside of these ranges can be used).

Suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be used include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulfoisophthalate), copoly propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

An unsaturated amorphous polyester resin can be used as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof. A suitable polyester resin can be a polyalkoxylated bisphenol A-co-terephthalic acid/dodecenylsuccinic acid/trimellitic acid resin, or a polyalkoxylated bisphenol A-co-terephthalic acid/fumaric acid/dodecenylsuccinic acid resin, or a combination thereof.

Suitable crystalline resins that can be used, optionally in combination with an amorphous resin as described above, include those disclosed in U.S. Patent Application Publication No. 2006/0222991, the disclosure of which is hereby incorporated by reference in its entirety. In embodiments, a suitable crystalline resin can include a resin formed of dodecanedioic acid and 1,9-nonanediol. For example, a polyalkoxylated bisphenol A-co-terephthalic acid/dodecenylsuccinic acid/trimellitic acid resin, or a polyalkoxylated bisphenol A-co-terephthalic acid/fumaric acid/dodecenylsuccinic acid resin, or a combination thereof, can be combined with a polydodecanedioic acid-co-1,9-nonanediol crystalline polyester resin.

### Surfactants

In some embodiments, toner particles disclosed herein may be formed in the presence of surfactants. For example, surfactants may be present in a range of from about 0.01 to about 20, or about 0.1 to about 15 weight percent of the reaction mixture. Suitable surfactants include, for example, nonionic surfactants such as dialkylphenoxypoly-(ethyleneoxy) ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. In some embodiments, an effective concentration of the nonionic surfactant may be in a range of from about 0.01 percent to about 10 percent by weight, or about 0.1 percent to about 5 percent by weight of the reaction mixture.

Suitable anionic surfactants may include, without limitation sodium dodecylsulfate (SDS), sodium dodecylbenzene sulfonate, sodium dodecylnaphthalene sulfate, dialkyl benzenealkyl, sulfates and sulfonates, adipic acid, available from Aldrich, NEOGEN R™, NEOGEN SC™, available from Kao, Dowfax 2A1 (hexa decyldiphenyloxide disulfonate) and the like, among others. For example, an effective concentration of the anionic surfactant generally employed is, for example, about 0.01 percent to about 10 percent by weight, or about 0.1 percent to about 5 percent by weight of the reaction mixture

In some embodiments, anionic surfactants may be used in conjunction with bases to modulate the pH and hence ionize the aggregate particles thereby providing stability and preventing the aggregates from growing in size. Such bases can be selected from sodium hydroxide, potassium hydroxide, ammonium hydroxide, cesium hydroxide and the like, among others.

Examples of additional surfactants, which may be added optionally to the aggregate suspension prior to or during the coalescence to, for example, prevent the aggregates from growing in size, or for stabilizing the aggregate size, with increasing temperature can be selected from anionic surfactants such as sodium dodecylbenzene sulfonate, sodium dodecylnaphthalene sulfate, dialkyl benzenealkyl, sulfates and sulfonates, adipic acid, available from Aldrich, NEOGEN R™, NEOGEN SC™ available from Kao, and the like, among others. These surfactants can also be selected from nonionic surfactants such as polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy) ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. For example, an effective amount of the anionic or nonionic surfactant generally employed as an aggregate size stabilization agent is, for example, about 0.01 percent to about 10 percent or about 0.1 percent to about 5 percent, by weight of the reaction mixture.

In some embodiments acids that may be utilized in conjunction with surfactants to modulate pH. Acid may include, for example, nitric acid, sulfuric acid, hydrochloric acid, acetic acid, citric acid, trifluoroacetic acid, succinic acid, salicylic acid and the like, and which acids are in embodiments utilized in a diluted form in the range of about 0.5 to about 10 weight percent by weight of water or in the range of about 0.7 to about 5 weight percent by weight of water.

### Waxes

In some embodiments, toner compositions may comprise a wax. Suitable waxes for the present toner compositions include, but are not limited to, alkylene waxes such as alkylene wax having about 1 to about 25 carbon atoms, polyethylene, polypropylene or mixtures thereof. The wax is present, for example, in an amount of about 6% to about 15% by weight based upon the total weight of the composition. Examples of waxes include those as illustrated herein, such as those of the aforementioned co-pending applications, polypropylenes and polyethylenes commercially available from Allied Chemical and Petrolite Corporation, wax emulsions available from Michaelman Inc. and the Daniels Products Company, EPOLENE N-15™ commercially available from Eastman Chemical Products, Inc., VISCOL 550-P™, a low weight average molecular weight polypropylene available from Sanyo Kasei K.K., and similar materials. The commercially available polyethylenes possess, it is believed, a molecular weight (Mw) of about 1,000 to about 5,000, and the commercially available polypropylenes are believed to possess a molecular weight of about 4,000 to about 10,000. Examples of functionalized waxes include amines, amides, for example Aqua SUPERSLIP 6550™, SUPERSLIP 6530™ available from Micro Powder Inc., fluorinated waxes, for example POLYFLUO 190™, POLYFLUO 200™, POLYFLUO 523XF™, AQUA POLYFLUO 41™, AQUA POLYSILK 19™, POLYSILK 14™ available from Micro Powder Inc., mixed fluorinated, amide waxes, for example Microspersion 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, chlorinated polypropylenes and polyethylenes available from Allied Chemical and Petrolite Corporation and SC Johnson Wax.

In some embodiments, the wax comprises a wax in the form of a dispersion comprising, for example, a wax having a particle diameter of about 100 nanometers to about 500 nanometers, water, and an anionic surfactant. In embodiments, the wax is included in amounts such as about 6 to about 15 weight percent. In embodiments, the wax comprises polyethylene wax particles, such as Polywax 850, commercially available from Baker Petrolite, although not limited thereto, having a particle diameter in the range of about 100 to about 500 nanometers, although not limited. The surfactant used to disperse the wax is an anionic surfactant, although not limited thereto, such as, for example, NEOGEN RK™ commercially available from Kao Corporation or TAYCAPOWER BN2060 commercially available from Tayca Corporation.

### Pigments and Colorants

Toner compositions disclosed herein may further comprise a pigment or colorant. Colorants or pigments as used herein include pigment, dye, mixtures of pigment and dye, mixtures of pigments, mixtures of dyes, and the like. For simplicity, the term “colorant” as used herein is meant to encompass such colorants, dyes, pigments, and mixtures, unless specified as a particular pigment or other colorant component. In embodiments, the colorant comprises a pigment, a dye, mixtures thereof, carbon black, magnetite, black, cyan, magenta, yellow, red, green, blue, brown, mixtures thereof, in an amount of about 1% to about 25% by weight based upon the total weight of the composition. It is to be understood that other useful colorants will become readily apparent to one of skill in the art based on the present disclosures.

In general, useful colorants include, but are not limited to, Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF) and particularly carbon blacks such as REGAL 330® (Cabot), Carbon Black 5250 and 5750 (Columbian Chemicals), and the like or mixtures thereof.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof. Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta E02 which can be dispersed in water and/or surfactant prior to use.

Other useful colorants include, for example, magnetites, such as Mobay magnetites MO8029, MO8960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like or mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide) phthalocyanine, x-copper phthalocyanine pigment listed in the Color Index as CI74160, CI Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components may also be selected as pigments.

### Coagulants

In some embodiments, toner compositions disclosed herein may comprise a coagulant. In some embodiments, the coagulants used in the present process comprise poly metal halides, such as polyaluminum chloride (PAC) or polyaluminum sulfo silicate (PASS). For example, the coagulants provide a final toner having a metal content of, for example, about 400 to about 10,000 parts per million. In another feature, the coagulant comprises a poly aluminum chloride providing a final toner having an aluminum content of about 400 to about 10,000 parts per million.

### Toner Particle Preparation

In some embodiments, a toner process comprises forming a toner particle by mixing a resin, such as a mixture or combination of the non-crosslinked latex with a quantity of the crosslinked latex, in the presence of a wax and a pigment dispersion to which is added a coagulant of a poly metal halide such as polyaluminum chloride while blending at high speeds such as with a polytron. The resulting mixture having a pH of about 2.0 to about 3.0 is aggregated by heating to a temperature below the resin Tg to provide toner size aggregates. Optionally, additional non-crosslinked latex is added to the formed aggregates providing a shell over the formed aggregates. The pH of the mixture is then changed by the addition of a sodium hydroxide solution until a pH of about 7.0 is achieved. When the mixture reaches a pH of about 7.0, the carboxylic acid becomes ionized to provide additional negative charge on the aggregates thereby providing stability and preventing the particles from further growth or an increase in the size distribution when heated above the Tg of the latex resin. The temperature of the mixture is then raised to about 95° C. After about 30 minutes, the pH of the mixture is reduced to a value sufficient to coalesce or fuse the aggregates to provide a composite particle upon further heating such as about 4.5. The fused particles are measured for shape factor or circularity, such as with a Sysmex FPIA 2100 analyzer, until the desired shape is achieved.

The mixture is allowed to cool to room temperature and is washed. A first wash is conducted such as at a pH of about 10 and a temperature of about 63° C. followed by a deionized water (DIW) wash at room temperature. This is followed by a wash at a pH of about 4.0 at a temperature of about 40° C. followed by a final DIW water wash. The toner is then dried.

While not wishing to be bound by theory, in the present toner composition comprising a non-crosslinked latex, a crosslinked latex, a wax, and a colorant, the crosslinked latex is primarily used to increase the hot offset, while the wax is used to provide release characteristics. The ratio of the non-crosslinked latex to the crosslinked latex, the wax content and the colorant content are selected to control the rheology of the toner.

In some embodiments, the toner comprises non-crosslinked resin, crosslinked resin or gel, wax, and colorant in an amount of about 68% to about 75% non-crosslinked resin, about 6% to about 13% crosslinked resin or gel, about 6% to about 15% wax, and about 7% to about 13% colorant, by weight based upon the total weight of the composition wherein a total of the components is about 100%, although not limited thereto. In embodiments, the non-crosslinked resin, the crosslinked resin or gel, the wax, and the colorant are present in an amount of about 71% non-crosslinked resin, about 10% crosslinked resin or gel, about 9% wax, and about 10% colorant, by weight based upon the total weight of the composition.

In embodiments, the toner composition comprises a Mw in the range of about 25,000 to about 40,000 or about 35,000, a Mn in the range of about 9,000 to about 13,000 or about 10,000, and a Tg (onset) of about 48° C. to about 62° C., or about 54° C. In embodiments of the present toner composition, the resultant toner possesses a shape factor of about 120 to about 140, and a particle circularity of about 0.930 to about 0.980.

### Composite Toner Particle

In embodiments, the colorant comprises a black pigment such as carbon black. In yet another embodiment, the colorant is a pigment comprising black toner particles having a shape factor of about 120 to about 140 where a shape factor of 100 is considered to be spherical and a circularity of about 0.900 to about 0.980 as measured on an analyzer such as a Sysmex FPIA 2100 analyzer, where a circularity of 1.00 is considered to be spherical in shape.

In another feature, the colorant comprises a pigment dispersion, comprising pigment particles having a volume average diameter of about 50 to about 300 nanometers, water, and an anionic surfactant. For example, the colorant may comprise carbon black pigment dispersion such as with Regal 300 commercially available, prepared in an anionic surfactant and optionally a non-ionic dispersion to provide pigment particles having a size of from about 50 nanometers to about 300 nanometers. In embodiments, the surfactant used to disperse the carbon black is an anionic surfactant such as Neogen RK™, or TAYCAPOWDER BN 2060, although not limited thereto. In some embodiments, an ultimizer type equipment is used to provide the pigment dispersion, although media mill or other means can also be used.

Optionally, other various known colorants such as dyes or pigments may be present in the toner and the toner can optionally be used as an additional color in the xerographic engine besides black and is selected in an effective amount of, for example, from about 1 to about 65 percent by weight based upon the weight of the toner composition, in an amount of from about 1 to about 15 percent by weight based upon the weight of the toner composition, or in an amount of from about 3 to about 10 percent by weight, for example.

The combined additive package of uncoated particles, silica, titania, and spacer particles are specifically applied to the toner surface with the total coverage of the toner ranging from, for example, as low as about 50% to as high as about 250% theoretical surface area coverage (SAC), in some embodiments from about 55% or about 70% to about 150 theoretical surface area coverage (SAC), where the theoretical SAC (hereafter referred to as SAC) is calculated assuming all toner particles are spherical and have a diameter equal to the volume median diameter of the toner as measured in the standard Coulter Counter method, and that the additive particles are distributed as primary particles on the toner surface in a hexagonal closed packed structure. Another metric relating to the amount and size of the additives is the sum of the “SAC×Size” (surface area coverage in percent times the primary particle size of the additive in nanometers) for each of the silica, titania, and spacer particles, or the like, for which all of the additives should, more specifically, have a total SAC×Size range of, for example, from about 500 to about 8,000, in embodiments from about 2,000 to about 5,000.

Thus, for example, in one embodiment, the additive package for the toner composition comprises silica in an amount of from about 1.8 to about 2.8 percent, titania in an amount of from about 1.5 to about 2.5 percent, and spacer particles in an amount of from about 0.6 to about 1.8 percent, where the percentages are by weight, based on a weight of the toner particles without the additive. In another embodiment, the additive package for the toner composition comprises silica in an amount of from about 1.9 to about 2.0 percent, titania in an amount of from about 1.7 to about 1.8 percent, and spacer particles in an amount of from about 1.7 to about 1.8 percent by weight. In some embodiments, additive package for the toner composition comprises about 1.963 percent silica, about 1.773 percent titania, and about 1.724 percent spacer particles.

For further enhancing the positive charging characteristics of the toner developer compositions, and as optional components there can be incorporated into the toner or on its surface charge enhancing additives inclusive of alkyl pyridinium halides, reference U.S. Pat. No. 4,298,672, the disclosure of which is totally incorporated herein by reference; organic sulfate or sulfonate compositions, reference U.S. Pat. No. 4,338,390, the disclosure of which is totally incorporated herein by reference; distearyl dimethyl ammonium sulfate; bisulfates, and the like, and other similar known charge enhancing additives. Also, negative charge enhancing additives may also be selected, such as aluminum complexes, like BONTRON E-88®, and the like. These additives may be incorporated into the toner in an amount of from about 0.1 percent by weight to about 20 percent by weight, and more specifically from about 1 to about 3 percent by weight.

The toner compositions described herein are further illustrated in the following examples. All parts and percentages are by weight unless otherwise indicated.

It will be appreciated that some of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

A stress machine test (A-zone; high toner area coverage) was developed that exacerbated the BCR contamination problem such that screening of potential alternative additives to replace CeO₂ could be done in a relatively short run machine test. Numerous alternative materials were tested as potential CeO₂ replacement additives to prevent the BCR contamination, but only a few showed adequate performances. Of the alternative additives tested, zirconium oxide (ZrO₂) demonstrated the excellent performance for preventing BCR contamination. The following details the testing and results.

A series of three emulsion aggregation high gloss (EA) magenta parent toners were blended to compare the effectiveness of different additives for preventing BCR contamination. Toner blending was accomplished using a 10 L Henschel blender, and a total of 1300 g toner was blended. The toners were blended and loaded into separate toner cartridges, the cartridges generally including 1) Standard magenta EA toner containing 0.55 wt % E10 CeO₂ additive as a control sample; 2) Magenta EA toner with the screened additives in place of CeO₂; and 3) Magenta EA toner with no additives.

TABLE 1

| Toner Additive | Amount | Supplier |
|---|---|---|
| CeO₂ (E10) | 0.55% | Mitsui Mining and |
| | | Smelting Co., Ltd |
| CeO₂ (W80) | 0.55% | Treibacher Industrie AG |
| Zirconium oxide (Zirox K) | 0.41% | Universal Photonics, Inc. |
| Silicon Carbide (059N) | 0.27% | Superior Graphite Co. |
| Zirconium oxide | 0.49% | Esprix Technologies |
| Barium titanate(PTC-BT-10 [symbol] | 0.50% | |
| Strontium titanate (PTC-ST-1 [symbol] | 0.41% | Esprix Technologies |
| Silicon nitride (M11) | 0.29% | H.C. Starck GmbH |
| Boron carbide (HD20) | 0.21% | H.C. Starck GmbH |
| Calcium zirconate | 0.38% | Esprix Technologies |
| Boron nitride (BN Hex) | 0.18% | NanoAmor, Inc. |
| Diamond dust | 0.30% | LANDS Superabrasives, Co. |

[symbol]

indicates data missing or illegible when filed

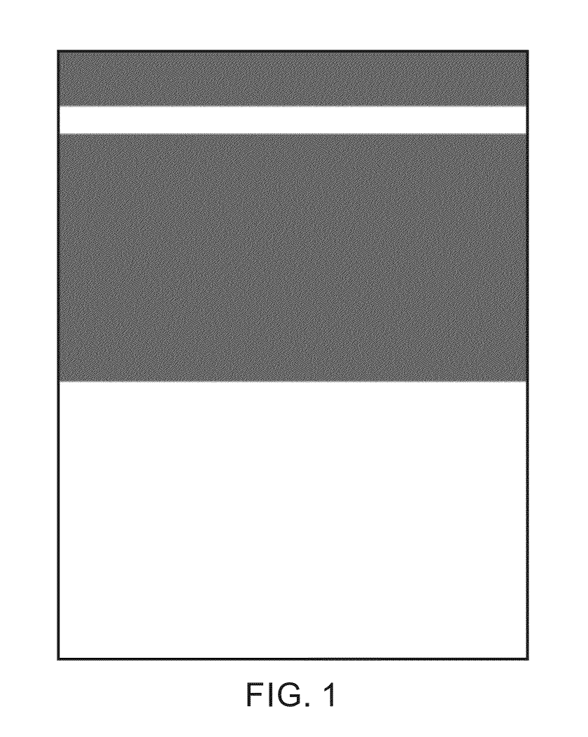

The toner cartridges were aged for one day in A-zone conditions (85% relative humidity; at 32° C.). The cartridges were then loaded into three different color positions in a DC250 machine. Machine testing was then done in A-zone, running 5000 prints at 50% area coverage using the print pattern shown in FIG. 1. This stress test highlighted BCR contamination in a relatively short-run machine test.

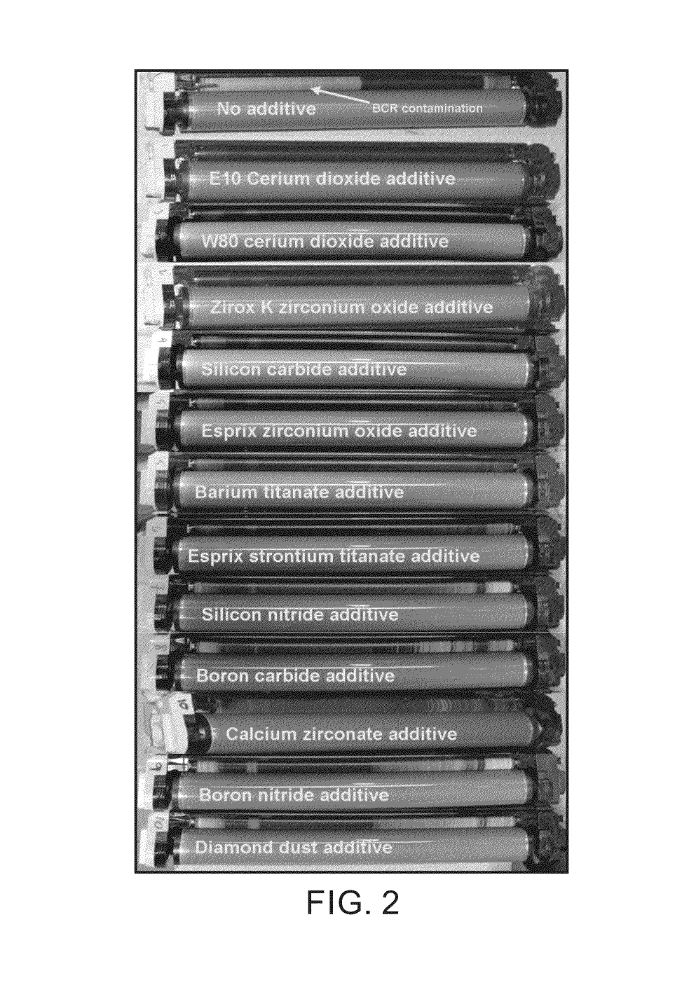

Toner samples were removed at 1000 print intervals during the test for analysis of chargeability (At), toner concentration (TC), and visual inspection of BCR. After 5000 prints, the machine test was complete and the Customer Replaceable Unit (CRU) was visually inspected for BCR contamination as shown in the series of photographs in FIG. 2 and Table 2.

TABLE 2

| | Measured | | | Predicted |
|---|---|---|---|---|
| | Visusal | | | Visusal |
| | BC [symbol] con- | | | BCR con- |
| | taminati [symbol] | Density | | tamination |
| Toner Additive | rating | g/cm³ | Conductivity | rating |
| None | 12 | NA | NA | NA |
| CeO₂ E10 | 1 | 6.4893 | 3.5503 × 10⁻⁸ | 2.3 |
| CeO₂ W80 | 3 | 6.802 | 2.95858 × 10⁻⁹ | 2.2 |
| ZrO₂ (Zirox K) | 2 | 4.8399 | 1.22424 × 10⁻⁹ | 5.7 |
| Silicon carbide | 4 | 3.1388 | 3.57143 × 10⁻⁷ | 3.9 |
| ZrO₂ (Esprix) | 5 | 5.7426 | 2.731 × 10⁻⁸ | 3.8 |
| Barium titanate | 5 | 5.84 | 2.21893 × 10⁻¹⁰ | 4 |
| Strontium | 6 | 4.8397 | 3.5503 × 10⁻¹¹ | 5.8 |
| titanate | | | | |
| Silicon nitride | 7 | 4.4222 | 1.01437 × 10⁻¹¹ | 6.5 |
| Boron carbide | 8 | 3.4 | 1.22424 × 10⁻¹¹ | 8.3 |
| Calcium | 9 | 2.5 | 1.69062 × 10⁻⁸ | 9.7 |
| zirconate | | | | |
| Boron nitride | 10 | 3.4907 | 1.26796 × 10⁻⁹ | 8.2 |
| Diamond dust | 11 | 2.0 | 3.94477 × 10⁻¹² | 10.7 |

[symbol]

indicates data missing or illegible when filed

Significant contamination (white section of the BCR) was observed on the BCR when no additive was included in the formulation, while E10 CeO₂ and select candidate additive materials prevented or reduced contamination. Thus, while a number of non-rare earth particle additives can be used to replace cerium dioxide for prevention of additive filming on the photoreceptor surface, only some of these additives are also effective in reducing or preventing BCR contamination as indicated in the photographs of FIG. 2 and tabulated in Table 2.

By compiling the test results a visual ranking scale was established, ranking the best result a 1 and then the next best a 2, and so on. A multi-regression model was built based on the density and the conductivity of the toner additive. Without being bound by theory, it has been postulated that materials that are effective for BCR contamination have a tendency to fall off the toner particles in the developer so that they end up on the photoreceptor surface and then ultimately on the BCR surface. Thus, a high toner additive density is expected to be more effectively pulled off the toner particles due to the effect of gravity and inertial forces which are proportional to the mass of the particles. If one maintains the same volume of particles, then it is the density of the particles (mass/volume) that will determine the amount of toner additive that will be pulled off the toner particles. One factor that may be important to the adhesion of the toner additive particle on the toner particle (and to the photoreceptor and/or BCR) is the charging ability of the toner additive. If the toner additive becomes strongly charged then it may be held more strongly to the toner particle, photoreceptor, or BCR. But to allow the toner additive particles to get to the photoreceptor and BCR, it must be easy to remove from the toner to the BCR. Also, if the toner additive is highly charged on the BCR it may be difficult to move over the surface, thus limiting its effectiveness as a cleaning additive. Thus, to be effective the toner additive may benefit from having low adhesion as correlates with low charge. One effective way to prevent charge build up is by making the toner additive particles sufficiently conductive to dissipate charge. Thus, consistent with the results of this Example, both conductivity and density of the toner additive are factors that warrant consideration to improve BCR contamination.

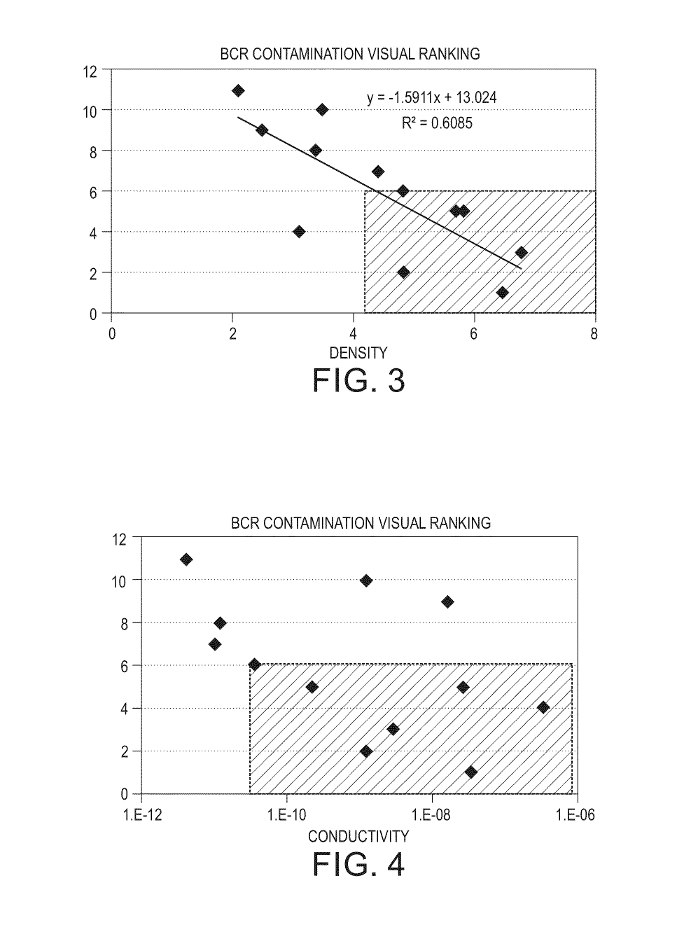

FIG. 3 shows a modest correlation of BCR contamination rating improvement with increasing density, however, if one sets a target of density 4 g/cm³ based on the observed correlation, to select those additives that improve BCR contamination (contamination being about less than or equal to about a 6 rating), then one would incorrectly include silicon nitride would be good, and miss silicon carbide, misclassifying it as a poor candidate.

FIG. 4 shows that there is also a modest correlation of BCR contamination rating improvement with increased conductivity, however, again there are significant deviations from that correlation, and one would misclassify calcium zirconate and boron nitride as good candidates given their high conductivity, when in fact they appear to be relatively ineffective. Thus, both high density and high conductivity are desirable, but neither is sufficient of itself to distinguish good from poorly performing toner additives.

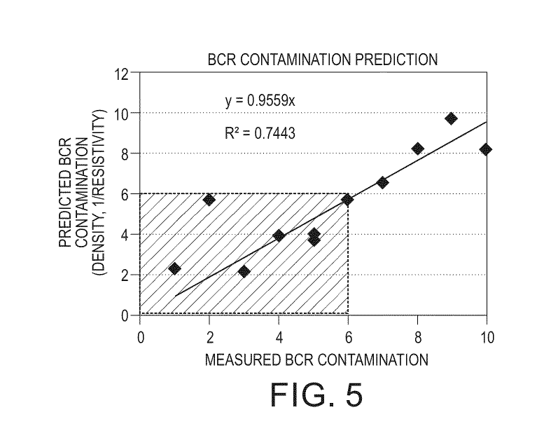

A model was built using Sigma Zone SPC XL fitting to density in g/cm³ and conductivity (1/resistivity, inverse resisitivity) in (ohm·cm)⁻¹. Both factors were highly significant at ≧98% confidence, and thus the model predicts the performance very well. The predicted versus observed fit is shown in the plot of FIG. 5. While there is still some scatter for one sample, all additives predicted to be good for preventing BCR contamination are good (BCR contamination less than or equal to about 6), and those that are poor for preventing BCR contamination are also correctly predicted to be poor. The predicted values are also shown in Table 2.

General Procedure for Density Measurement

Densities of the particles were measured using a Micrometrics AccuPyc 1330 using the standard procedures according to the supplied manual. Typically 5 to 10 grams of the additive were used for the measurements.

General Procedure for Conductivity Measurement

Conductivity was measured in a custom-made fixture connected to an HP 4339A High Resistance Meter. To insure reproducibility and consistency, one gram of sample was conditioned in J-zone overnight, then placed in a mold having 1-in diameter and pressed by a precision-ground plunger at about 2500 psi for 2 minutes. While maintaining contact with the plunger (which acts as one electrode), the pellet was then forced out of the mold onto a spring-loaded support, which keeps the pellet under pressure and also acts as the counter electrode. The current set-up eliminates the need for using additional contact materials (such as tin foils or grease) and also allows the in-situ measurement of pellet thickness. Resistivity was determined by measuring the resistance of the sample at 10V, where, resistivity=(ohms*5.07)/length and 5.07 is the area of pellet in cm², divided by the length gives ohm-cm. Conductivity is 1/resistivity, i.e. inverse resistivity.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

1. A toner composition comprising toner particles and a plurality of additives disposed on an exterior surface of the toner particles, the additives comprising:
uncoated particles satisfying the equation:
14.428−1.793×density(g/cm³)−1,363,353×conductivity(ohm·cm⁻¹)≦6; the equation being optionally satisfied by selection of a reagent comprising one selected from the group consisting of zirconium oxide, barium titanate, and silicon carbide; and wherein the uncoated particles have an average particle size in a range of from about 0.5 to about 0.7 microns,
surface-treated silica;
surface-treated titania; and
spacer particles;
wherein the toner composition is substantially free of a rare earth compound and
wherein the uncoated particles are present in a sufficient amount to reduce bias charge roller contamination.

2. The toner composition of claim 1, the uncoated particles are present in a range of from about 0.20 weight percent to about 0.50 weight percent.

3. The toner composition of claim 1, wherein the toner particles are made by an emulsion/aggregation coalescence process.

4. A toner composition comprising toner particles and a toner additive disposed on an exterior surface of the toner particles, the toner additive comprising uncoated particles having a density greater than or equal to about 4.7 g/cm³ and a conductivity greater than or equal to about 2×10⁻¹¹ ohm·cm⁻¹, the uncoated particles optionally being selected from the group consisting of zirconium oxide, barium titanate, and silicon carbide; wherein the uncoated particles have an average particle size in a range of from about 0.5 to about 0.7 microns; and
wherein the toner composition is substantially free of one or more rare earth compounds and wherein the uncoated particles are present in a sufficient amount to reduce bias charge roller contamination.

5. The toner composition of claim 4, wherein the uncoated particles are present in a range of from about 0.25 weight percent to about 0.55 weight percent.

6. The toner composition of claim 5, wherein the uncoated particles are present in a range of from about 0.30 weight percent to about 0.50 weight percent.

7. (canceled)

8. The toner composition of claim 4, wherein the uncoated particles are irregular in shape or substantially spherical.

9. The toner composition of claim 4, wherein the toner particles are made by an emulsion/aggregation coalescence process.

10. The toner composition of claim 4, wherein the toner additive further comprises at least one of surface-treated silica, surface-treated titania, spacer particles, and combinations thereof.

11. The toner composition of claim 10, wherein the surface-treated silica is present in an amount of from about 1.6 weight percent to about 2.8 weight percent based on the weight of the toner particle.

12. The toner composition of claim 10, wherein the surface-treated silica has an average particle size of from about 20 to about 50 nm.

13. The toner composition of claim 10, wherein the surface-treated titania is present in an amount of from about 0.5 weight percent to about 2.5 weight percent based on the weight of the toner particle.

14. The toner composition of claim 10, wherein the surface-treated titania has an average particle size of from about 20 to about 50 nm.

15. The toner composition of claim 10, wherein the spacer particles are present in an amount of from about 0.6 weight percent to about 1.8 weight percent based on the weight of the toner particle.

16. The toner composition of claim 10, wherein the spacer particles have an average particle size of from about 100 to about 150 nm.

17. The toner composition of claim 10, wherein the spacer particles are selected from the group consisting of latex particles, polymer particles, and sol-gel silica particles.

18. A toner composition comprising toner particles and a plurality of additives disposed on an exterior surface of the toner particles, the additives comprising:
about 0.20 weight percent to about 0.50 weight percent of uncoated particles having a density greater than or equal to about 4.7 g/cm³ and a conductivity greater than or equal to about 2×10⁻¹¹ ohm·cm⁻¹; the uncoated particles optionally being selected from the group consisting of zirconium oxide, barium titanate, and silicon carbide; wherein the uncoated particles have an average particle size in a range of from about 0.5 to about 0.7 microns;
surface-treated silica;
surface-treated titania; and
spacer particles;
wherein the toner composition is substantially free of one or more rare earth compounds.

19. (canceled)

20. The toner composition of claim 18, wherein the toner particles are made by an emulsion/aggregation coalescence process.
